(19) United States
(12) Patent Application Publication
(10) Pub. No.: US 2012/0237634 A1
(43) Pub. Date: Sep. 20, 2012

(54) USE OF AT LEAST ONE MICROORGANISM BELONGING TO THE SPECIES AUREOBASIDIUM PULLULANS AS A FERMENTATION AID FOR FRUITS

(76) Inventors: Eva Maria Binder, Tulln (AT); Herbert Danner, Zwentendorf (AT); Christina Donat, Bierbaum am Kleebuhl (AT)

(21) Appl. No.: 13/511,012

(22) PCT Filed: Nov. 19, 2010
(86) PCT No.: PCT/AT2010/000452

§ 371 Date: May 21, 2012

(30) Foreign Application Priority Data
Nov. 20, 2009 (AT) A 1847/2009

(51) Int. Cl. C12G 1/022

(52) U.S. Cl. 426/15; 426/52

(57) ABSTRACT

The invention relates to the use of at least one microorganism belonging to the species Aureobasidium pullulans, selected from among Aureobasidium pullulans DSM 14940 or Aureobasidium pullulans DSM 14941, as a fermentation aid for fruits.

The present invention relates to the use of at least one micro-organism belonging to the species Aureobasidium pullulans.

Microorganisms of the species Aureobasidium pullulans belong to the yeast-like fungi frequently occurring in soils, potting media, plant parts, compost, waste water, fruits, fruit products and on seeds as well as on various construction materials. On the one hand, individual strains of Aureobasidium pullulans, are dreaded material destroyers capable of degrading cellulose in plant fibers of any kind, which may even affect wood, yet, on the other hand, different Aureobasidium pullulans strains constitute important organisms in biotechnology. Thus, Aureobasidium pullulans strains, for instance, serve as producers of pullulan, which is used as a thickening agent and an additive to energy-reduced food and also as a lubricant in the production of synthetic fibers.

Recently, Aureobasidium pullulans strains have also been used as sprays in acidic milieus for the production of, and/or use in, plant protection or plant strengthening agents for combating bacterial and/or fungal plant diseases and, in particular, fire blight. Unlike with conventional sprays, the use of such sprays based on reproducible fungal structures offers the advantage that no toxic residues of the spray will be detected in the fruits or fruit trees treated therewith. Particularly the use of sprays based on antibiotics involves the problem of developing resistance, which is not to be feared with fungal sprays, the latter thus offering substantial advantage. The use of sprays based on Aureobasidium pullulans will thus not require a retention period for pre-harvest spraying and, in particular, will not involve the formation of resistance against certain antibiotic strains.

In addition to sprays that are suitable for stone fruits in combating fire blight, which are based on specific Aureobasidium pullulans strains, sprays that are active against gray mold in various crop plants have recently also been developed, likewise using selected Aureobasidium pullulans strains. In those cases, the plants or fruits such as tomatoes, wine, yet even house plants are sprayed several times with a spray containing Aureobasidium pullulans after flowering and before harvesting in order to prevent or reduce the development of Botrytis cinerea and, in particular, gray mold, which would have negative effects on unripe fruits. The use of such sprays based on Aureobasidium pullulans particularly in fruit production has the advantage that the plants and, in particular, fruits can or may be sprayed even shortly before the harvest, since no retention period exists, which would be imposed for the use of chemical sprays, this being of particular advantage in humid summers, since humidity favors the development of gray mold.

It has now been surprisingly found that, in addition to the activity of Aureobasidium pullulans against the fire blight pathogen and plant diseases caused by Botrytis cinerea, specific strains of the species Aureobasidium pullulans are active against further microorganisms present on the surfaces of plants and fruits and, in particular, are able to prevent the negative effects of these microorganisms on the quality of alcoholic beverages produced from fruits, so that the present invention aims at the use of at least one special microorganism belonging to the species Aureobasidium pullulans for the production of a fermentation aid for fruits.

To solve this object, at least one microorganism belonging to the species Aureobasidium pullulans and selected from Aureobasidium pullulans DSM 14940 or Aureobasidium pullulans DSM 14941 is used according to the invention as a fermentation aid for fruits.

For the production of alcoholic beverages from fruits by the fermentation of fruit juices or fruit mashes, either a so-called spontaneous fermentation is usually applied, using the yeasts present on the fruits to ferment the sugars contained in the fruit juices or mashes, wherein such spontaneous fermentations frequently lead to faulty fermentations or incomplete fermentations, since the naturally occurring yeast populations are frequently not sufficiently efficient to convert all the sugar into alcohol. In addition to the usually unfavorable temperature conditions prevailing during fermentation, the lack of yeast-utilizable nutrients and turbid particles in the fruit juice or mash will also create excessive stress to the yeasts, which may likewise result in a faulty fermentation or fermentation inhibition during a spontaneous fermentation.

Even if cultured yeasts are added to the fermentation, the fermentation of fruit mashes or fruit juices may get stuck, and, in particular, any further addition of cultured yeasts or yeast nutrient salts or an increase in the fermentation temperature will usually have adverse effects on the quality of the produced fermentation product such as, for instance, wine or must, so that attempts will have to be made that such fermentation will be achieved as rapidly and completely as possible.

By the use according to the invention of the Aureobasidium pullulans strains DSM 14941 and DSM 14940 as fermentation aids for fruits it has surprisingly become possible to not only accelerate the fermentation as a whole, but also achieve a complete fermentation without fermentation faults or a fermentation stop, particularly when applying a spontaneous fermentation using the yeast strains directly present on the fruits.

If, in particular, the Aureobasidium pullulans strains DSM 14940 or DMS 14941 are used for the production of a fermentation aid for grapes, as in correspondence with a further development of the present invention, it will be possible, following the consumer trend, to produce pure, fresh and fruit-driven wines and, in particular, also ferment terroir wines produced by the spontaneous fermentation of Saccharomyces strains present on the grapes safely and reliably as well as completely and, in particular, rapidly while preventing fermentation faults with certainty.

By using the microorganism in a manner that it is applied onto the fruits as an aqueous suspension, or directly introduced into a fruit mash, as in correspondence with a further development of the invention, any microorganisms interfering with the fermentation will be successfully to suppressed immediately before the fermentation by the application of an aqueous suspension comprising at least one of the Aureobasidium pullulans strains DSM 14940 or DMS 14941, and the fermentation of the fruit mash or the fruit juice produced from the mash will thereby be accelerated while, in particular, ensuring that the fermentation will proceed to completion without being stuck. In a surprising manner, a marked improvement in the fermentation behavior relative to grapes treated with conventional agents against Botrytis cinerea could be achieved by the use according to the invention.

In that the use according to the invention takes place in such a manner that the aqueous suspension is applied onto the fruits at least twice prior to the production of a fruit mash, a further improvement in the resultant fermentation and, in particular, a further acceleration of the fermentation of the fruits will be achieved. The at least twice application onto the fruits of the suspension, which, as opposed to the suspensions used as spraying agents, does not comprise an acidic milieu, prior to the preparation of a fruit mash has turned out to be particularly advantageous, wherein the application onto storable fruits can be performed twice after the harvest of the fruits, or if the fruits are non-storable or easily perishable such as grapes, the aqueous suspension can optionally also be applied onto the fruits once immediately before the harvest in order to ensure that any microorganisms harmful to the fermentation will be rendered harmless. By such a use of at least one Aureobasidium pullulans strain, it will, in particular, be possible to positively influence the fermentation behavior of fruit juices, especially wine, with a rapid and complete fermentation being observable, in particular with a spontaneous fermentation.

By controlling the use according to the invention in a manner that the microorganism is contained in the aqueous suspension at a concentration of 5×10⁷ CFU/l to 5×10¹¹ CFU/l, preferably 1×10⁹ CFU/l to 1×10¹⁰ CFU/l, the complete elimination of fermentation-interfering microorganisms from the fruit mash or from the surfaces of the fruits to be fermented will be achieved in addition to an acceleration of the fermentation, especially the spontaneous fermentation, such that a faulty fermentation or a fermentation inhibition will be safely excluded. When using in the suspension the concentrations contemplated by the invention of the microorganisms Aureobasidium pullulans DSM 14940 and/or DSM 14941, it will also be safeguarded that no interference with the juice fermentation of fruits will occur and no infection of the crop by secondary pathogens such as Penicillium, Aspergillus, sour rot, Trichothezium, Cladosporium or Alternaria will take place.

In that, as in correspondence with a further development of the present invention, the microorganism is used in a manner present in immobilized form on an inert carrier, in particular bentonite, zeolite or diatomaceous earth, yeast or yeast cell walls, milk powder, whey powder, potassium sulfate or potassium carbonate, a further accelerated fermentation and, in particular, the simultaneous removal or separation of undesired harmful substances will be achieved. If, for instance, the microorganism is, in particular, used in a manner present in immobilized form on yeast or yeast cell walls, the fermentation can be further accelerated or further supported by selectively choosing the used yeasts, in particular, with a view to ensuring a rapid and complete fermentation and safely avoiding any residual sugar upsetting the alcoholic beverage produced.

In that, as in correspondence with a further development of the present invention, the use is controlled in such a manner that the microorganisms Aureobasidium pullulans DSM 14940 and Aureobasidium pullulans DSM 14941 are used at a ratio of 10:90 to 90:10, the positive actions of both of the two different Aureobasidium pullulans strains DSM 14940 and DSM 14941 will be provided during the fermentation of the fruits, wherein the ratio of the two Aureobasidium pullulans strains relative to each other is arbitrarily adjusted as a function of the annoying microorganisms contained on the fruits or in the mash. In order to prevent infections by secondary pathogens, particularly when fermenting fruits that are prone to infestation with Botrytis cinerea, such as grapes, raspberries, strawberries and blackberries, it has turned out to be beneficial for such fruits, due to their sensitivity to rot and infestation with Botrytis, to perform at least one spraying with a suspension comprising Aureobasidium pullulans strains DSM 14940 and DSM 14941 already before the harvest, thus giving the Aureobasidium pullulans strains sufficient time to compete with the harmful pathogens for nourishment and habitat such that the content of interfering microorganisms will already be markedly reduced when harvesting the plants. Additional spraying immediately following the harvest or during the inoculation of the mash with the used microorganisms will further reduce the content of harmful substances so as to enable the subsequent fermentation, in particular the spontaneous fermentation, of the fruits to proceed completely and quickly.

In order to achieve a complete and reliable fermentation with fruits comprising few fermentation-promoting yeasts on their surfaces, such as apples and pears, the use according to the present invention is controlled in a manner that the fermentation aid is supplemented with an additional 5 to 95% of naturally occurring Saccharomyces cerevisiae strains, based on the overall amount of microorganisms.

In the following, the invention will be explained in more detail by way of exemplary embodiments illustrated in the drawing, wherein:

FIG. 1 depicts a diagram illustrating the fermentation of Welschriesling grapes, wherein, in one case, grapes treated against Botrytis cinerea were subjected to a normal spontaneous fermentation and, in another case, a mash of the same Welschriesling grapes treated by using Aureobasidium pullulans DSM 14940 and Aureobasidium pullulans DSM 14941 at a ratio of 50:50 was subjected to a spontaneous fermentation;

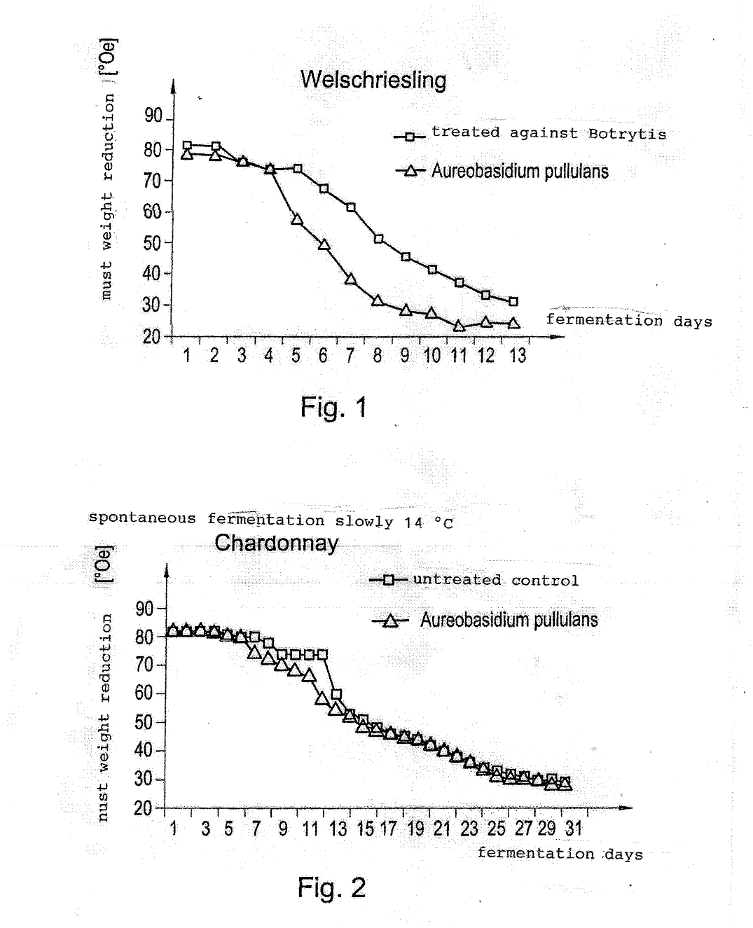

FIG. 2 illustrates a slow spontaneous fermentation of Chardonnay grapes, comparing an untreated control with a batch treated by using a mixture of Aureobasidium pullulans DSM 14940 and DSM 14941 at a ratio of 70:30;

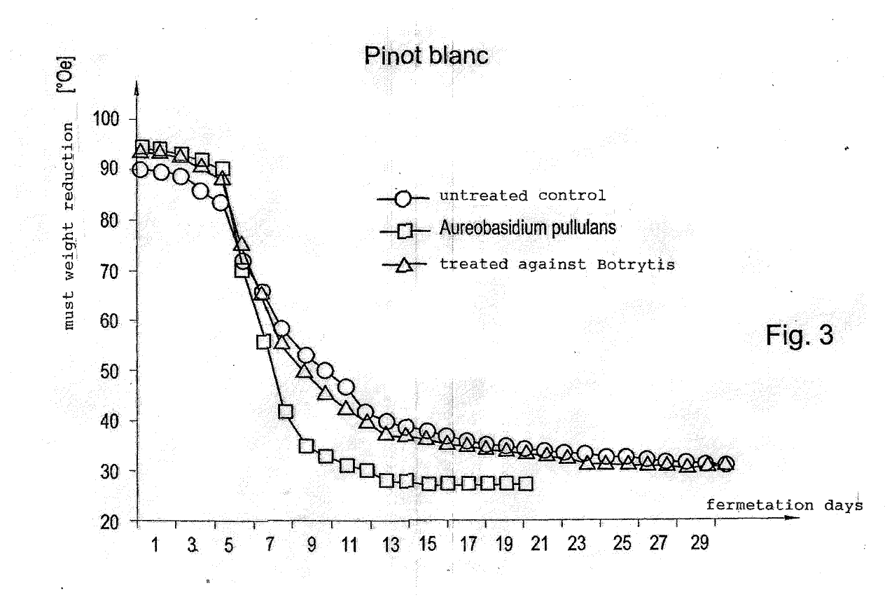

FIG. 3 illustrates the fermentation of Pinot Blanc grapes after the addition of cultured yeasts, wherein an untreated control is compared with a batch treated by using Aureobasidium pullulans DSM 14940 and DSM 14941 at a ratio of 20:80 as well as a batch sprayed against Botrytis cinerea;

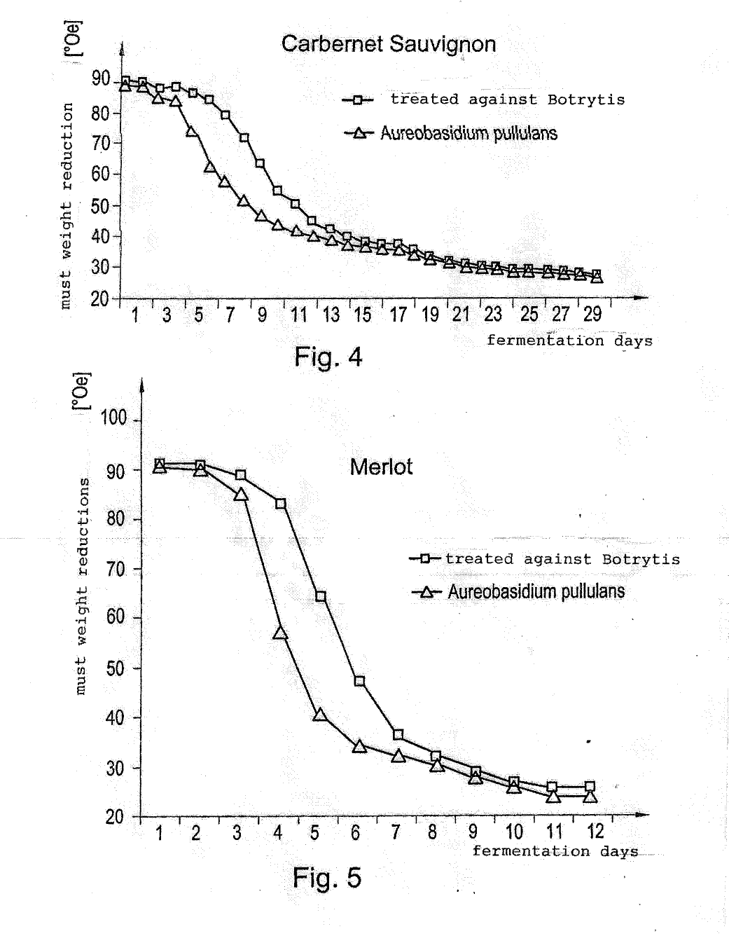

FIG. 4 illustrates the slow spontaneous fermentation of a mash of Cabernet Sauvignon grapes, wherein a comparison of a must batch in which the grapes were treated against Botrytis cinerea before the harvest is plotted against a batch treated by the addition of Aureobasidium pullulans DSM 14940 and Aureobasidium pullulans DSM 14941 at a ratio of 55:45;

FIG. 5 illustrates the fermentation of Merlot grape-containing mashes after the addition of cultured yeasts, wherein a batch treated against Botrytis cinerea is compared to a batch treated by the use of Aureobasidium pullulans DSM 14940 and DSM 14941 at a ratio of 10:90; and

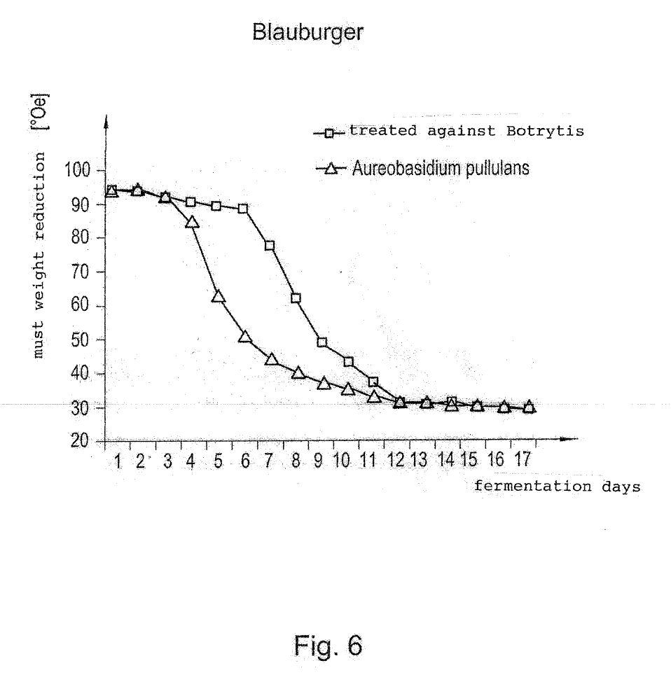

FIG. 6 illustrates the spontaneous fermentation of a mash containing Blauburger grapes, wherein a batch treated against Botrytis cinerea is compared to a batch supplemented with Aureobasidium pullulans DSM 14940 and DSM 14941 at a ratio of 50:50.

Moreover, a comparative test was performed for the juice fermentation of apple juice, wherein an untreated apple must was used in one case and an apple juice comprising apples treated by the use of an Aureobasidium pullulans DSM 14940 suspension immediately after the harvest was used in the other case.

In FIG. 1, the number of fermentation days is plotted on the abscissa and the must weight reduction during the fermentation in ° Oe (degree Ochsle) is plotted on the ordinate. From the diagram of FIG. 1 it is apparent that, when using grapes treated against Botrytis cinerea, the fermentation proceeds slowly despite the addition of cultured yeasts and is not yet fully completed on the 13^{th} day of fermentation such that, in particular in a wine resulting from such fermentation, a faulty, overlying sweetness will have to be expected, which will be felt as a drawback, or recognized as a fault, by the consumers, in particular in the case of a fresh and fruity young white wine, what a Welschriesling is usually expected to be.

On the other hand, when using grapes treated by the use of Aureobasidium pullulans DSM 14940 and Aureobasidium pullulans DSM 14941 at a ratio of 50:50, namely, in particular, once by spraying twice with a substantially neutral suspension of the Aureobasidium pullulans strains DSM 14941 and DSM 14940 some days and immediately before the harvest as well as once after the preparation of a mash without addition of a cultured yeast to the mash, a considerably faster reduction of the must weight will be observed, and the fermentation will, moreover, already be completed after day 11 such that a Welschriesling produced by such a fermentation process will neither contain residual sweetness overlying faults nor be incompletely fermented.

FIG. 2 illustrates a slow spontaneous fermentation of Chardonnay grapes at 14° C., depicting a comparison of an untreated control with a batch using Aureobasidium pullulans DSM 14940 and DSM 14941 added to the fermenting juice at a ratio of 70:30.

From this diagram, it is clearly apparent that, in particular at the spontaneous fermentation of the untreated control, the fermentation started only slowly and was fully inhibited particularly between the days 9 and 13 such that the formation of wine faults and, in particular, undesired fermentation by-products had to be feared. On day 13, the stuck fermentation was reactivated by the addition of yeast and nutrient salts, subsequently proceeding quickly until a slow, complete fermentation of the grape juice was achieved.

The Chardonnay grapes treated with Aureobasidium pullulans also showed a flattening of the fermentation curve in the period between days 7 and 11, said fermentation having, however, automatically continued without further inoculation of cultured yeasts and without addition of nutrient salts and, from day 14, having proceeded approximately in the same manner as the fermentation of the untreated control. From this result, it can be taken that, in particular in the spontaneous fermentation, the addition of Aureobasidium pullulans DSM 14941 and/or DSM 14940 ensures that the spontaneous fermentation will reliably continue without stoppage or inhibition in any manner whatsoever.

FIG. 3 illustrates the rapid fermentation of Pinot Blanc grapes after the addition of a cultured yeast, wherein it is apparent that an untreated control ferments approximately equally rapidly as a batch of Pinot Blanc grapes treated against Botrytis cinerea. Between day 5 and 9, a relatively rapid fermentation takes place, after which the fermentation curve flattens between days 9 and 12 to subsequently continue only slowly from day 12 until a complete fermentation is reached beginning on day 22.

By contrast, the Pinot Blanc grapes treated with the Aureobasidium pullulans strains DSM 14940 and DSM 14941 at a ratio of 20:80 during the first five days ferment approximately concurrently with the two other groups of grapes. From day 5, a steep decrease of the fermentation curve until day 9 is to be observed, which corresponds to a rapid thorough fermentation of the grape must, whereupon a strong flattening of the fermentation curve until day 13 occurs, with the grapes having to be considered as fully fermented from day 13.

This comparison clearly reveals that the Pinot Blanc grapes treated by the addition of Aureobasidium pullulans DSM 14940 and/or DSM 14941 ferment considerably more rapidly such that, in particular, a lean and dry white wine free of fermentation faults is to be expected.

FIG. 4 illustrates the slow spontaneous fermentation of a mash containing Cabernet Sauvignon grapes, wherein the fermentation took place directly on the skins during the first 10 days, and the pressed red must subsequently fermented to completion. From the diagram, it is clearly apparent that, in the spontaneous fermentation of the mash batch containing the Cabernet Sauvignon grapes treated against Botrytis cinerea, the spontaneous fermentation started around day 6, running relatively quickly until day 13, whereupon only a slow residual fermentation occurred.

For the mash containing the Cabernet Sauvignon grapes treated with Aureobasidium pullulans DSM 14940 and DSM 14941 at a ratio of 55:45 immediately before the harvest, it was shown that the spontaneous fermentation already started on day 3, running very quickly from days 4 to 10 and subsequently proceeding only slowly until a final fermentation was achieved. Pressing of the red must did not interrupt the fermentation, i.e. neither with the batch treated against Botrytis cinerea nor with the batch treated with Aureobasidium pullulans DSM 14940 and DSM 14941 at a ratio of 55:45.

Overall, it is, however, apparent that the spontaneous fermentation of the mash containing the grapes treated with Aureobasidium pullulans started rapidly and continued without interruption until the complete fermentation of the mash or pressed red must, respectively.

In FIG. 5, the rapid fermentation of a mash containing Merlot grapes is illustrated, wherein the total fermentation was performed directly on the skins and the must was not pressed before the end of the fermentation. The fermentation of both mash batches took place after the addition of a cultured yeast, wherein it is apparent that the batch treated against Botrytis cinerea started to ferment on day 3 and the fermentation ran quickly until day 7, whereupon the fermentation curve flattens between day 7 and 12.

By contrast, the mash of Merlot grapes, which contained grapes that had been treated with the Aureobasidium pullulans strains DSM 14940 and DSM 14941 at a ratio of 10:90 prior to picking, fermented slightly more quickly, with the fermentation, in particular, already starting on day 2 and proceeding very quickly between days 3 and 5, whereupon the fermentation curve flattened slowly between days 5 and 7 to subsequently approximately coincide with the fermentation curve of the batch treated against Botrytis. The mash can be regarded as completely fermented on about day 11.

This comparison reveals that the mash or skin fermentation of Merlot grapes treated with Aureobasidium pullulans before picking clearly starts off more rapidly and, in particular, ferments to completion more rapidly such that a red wine having no fermentation faults is to be expected.

FIG. 6 illustrates the spontaneous fermentation of mashes containing Blauburger grapes, one batch comprising grapes treated with a conventional agent against Botrytis cinerea before the harvest and a second batch comprising grapes treated with Aureobasidium pullulans DSM 14940 and DSM 14941 at a ratio of 50:50 before the harvest.

A comparison of the two curves reveals that the spontaneous fermentation of the mash containing grapes treated against Botrytis cinerea did not get started before day 6, whereupon the mash was heated to 45° C. in order to extract the color from the red grapes, on the one hand, and to initiate the fermentation process, on the other hand. After mash-heating and crushing, the fermentation started at once and the grape juice was fermented to completion by day 12.

The second mash batch, which contained the Blauburger grapes treated with Aureobasidium pullulans DSM 14940 and DSM 14941 at a ratio of 50:50 before the harvest, showed that the spontaneous fermentation automatically started on day 3, proceeded very quickly until day 7, whereupon the fermentation curve flattened to coincide, on day 12, with that of the charge conventionally treated against Botrytis cinerea.

It is apparent from the fermentation curves that, due to the fermentation inhibition of the mash containing the grapes conventionally treated against Botrytis cinerea, fermentation faults were supposed to be expected in the produced wine, and, besides, the spontaneous fermentation could only get started by heating the mash, which meant that a further decrease of the quality of the produced red wine was to be feared. By contrast, the spontaneous fermentation of the mash containing Blauburger grapes treated with Aureobasidium pullulans DSM 14940 and DSM 14941 at a ratio of 50:50 before to the harvest proceeded uniformly and rapidly without interruption such that a lean red wine having, in particular, no fermentation faults was to be expected.

### Comparative Test

### Juice Fermentation of Cider Apples

An untreated apple must was supplemented with cultured yeasts to produce an apple wine and a cider, wherein the fermentation was completed within 6 days and an apple wine with an alcoholic content of 7% was produced. For further storage of the product, the yeast had to be quickly removed in order to prevent the risk of microbially induced wine faults and, in particular, the growth of undesired microorganisms due to the low alcoholic content of the apple wine.

A second batch of cider apples was once treated with the Aureobasidium pullulans DSM 14940 suspension before the harvest, and a further batch of Aureobasidium pullulans DSM 14940 was once added to the fruit mash. Further fermentation proceeded analogously to that of the first batch of cider apples, with the fermentation speed having been slightly faster than in the first group.

It has, however, been shown in a surprising manner that the produced apple wine was considerably more stable than the comparative wine and that, in particular, its susceptibility to microbially induced wine faults and the growth of undesired microorganisms leading to spoilage of the wine were markedly reduced and, in particular, also the yeast did not have to be removed that rapidly.

1. A use of at least one microorganism belonging to the species Aureobasidium pullulans and selected from Aureobasidium pullulans DSM 14940 or Aureobasidium pullulans DSM 14941 as a fermentation aid for fruits, i.e. as an agent for accelerating, and/or an agent for completing, the fermentation of fruits.

2. The use according to claim 1, characterized in that the fruits are grapes.

3. The use according to claim 1, characterized in that the microorganism is applied onto the fruits as an aqueous suspension, or is directly introduced into a fruit mash.

4. The use according to claim 3, characterized in that the aqueous suspension is applied onto the fruits at least twice prior to the production of a fruit mash.

5. The use according to claim 1, characterized in that the microorganism is contained in the aqueous suspension at a concentration of 5×10⁷ CFU/l to 5×10¹¹ CFU/l, preferably 1×10⁹ CFU/l to 1×10¹⁰ CFU/l.

6. The use according to claim 1, characterized in that the microorganism is present in immobilized form on an inert carrier, in particular bentonite, zeolite or diatomaceous earth, yeast or yeast cell walls, milk powder, whey powder, potassium sulfate or potassium carbonate.

7. The use according to claim 1, characterized in that the microorganisms Aureobasidium pullulans DSM 14940 or Aureobasidium pullulans DSM 14941 are used at a concentration of 10:90 to 90:10.

8. The use according to claim 1, characterized in that the fermentation aid is supplemented with an additional 5 to 95% of naturally occurring Saccharomyces cerevisiae strains, based on the overall amount of microorganisms.
